(19) United States
(12) Patent Application Publication
(10) Pub. No.: US 2018/0345798 A1
(43) Pub. Date: Dec. 6, 2018

(54) VEHICLE

(71) Applicant: HONDA MOTOR CO., LTD., Tokyo (JP)

(72) Inventor: Naoya Sakakibara, Wako-shi (JP)

(73) Assignee: HONDA MOTOR CO., LTD., Tokyo (JP)

(21) Appl. No.: 15/992,612

(22) Filed: May 30, 2018

(30) Foreign Application Priority Data
May 30, 2017 (JP) 2017-106583

(51) Int. Cl. B60L 11/00; B60L 11/18

(52) U.S. Cl. CPC B60L 11/002; B60L 11/1814; B60L 2240/80; B60L 2210/10; B60L 11/1816

(57) ABSTRACT

A vehicle includes a high-voltage battery, a battery heating unit, and an electrical component such as a DC-DC converter, which are capable of being supplied with electrical power by an external power supply, and includes a state-of-charge acquiring unit that acquires a value of the output voltage of the high-voltage battery, a supplied-current-amount acquiring unit that acquires the amount of current supplied to the electrical component, and a control unit that controls an in-vehicle charger such that, when the output voltage is equal to or higher than a voltage threshold, and the supplied current amount is equal to or lower than a threshold, charging of the high-voltage battery performed by the external power supply is stopped and that electrical power is supplied to the electrical component from the high-voltage battery.

### CROSS REFERENCES TO RELATED APPLICATIONS

The present application claims priority under 35 U.S.C. § 119 to Japanese Patent Application No. 2017-106583, filed May 30, 2017, entitled “Vehicle.” The contents of this application are incorporated herein by reference in their entirety.

### TECHNICAL FIELD

The present disclosure relates to a vehicle.

### BACKGROUND

A vehicle that is equipped with a high-voltage battery and a low-voltage battery, the high-voltage battery being capable of receiving charging power from an external power supply unit, has been becoming popular. There is such a vehicle having a configuration in which an external power supply unit is capable of also supplying electrical power for operating electrical components including electrical components that are arranged inside the vehicle and a heating device for a battery (see, for example, International Publication No. 2011/099116). With the technology disclosed in International Publication No. 2011/099116, a high-voltage battery is charged by an external power supply unit, and on the other hand, when the state of charge of the low-voltage battery that supplies electrical power for operating electrical components reaches a level equal to or lower than a predetermined level, the low-voltage battery is charged by the high-voltage battery.

When a high-voltage battery is charged by an in-vehicle charger that operates with electrical power supplied by an external power supply unit, the amount of charging power is generally reduced as the state of charge of the high-voltage battery becomes close to a fully-charged level in accordance with the progress of the charging. This reduction is performed in order to prevent overcharging of the high-voltage battery, which in turn results in a reduction in the service life of the high-voltage battery. With a configuration in which an in-vehicle charger charges a high-voltage battery and also supplies electrical power for operating electrical components, the high-voltage battery may be charged with the output power of the in-vehicle charger, and surplus electrical power may be consumed by the electrical components. As a result, the probability of the high-voltage battery being overcharged may be reduced up to a point. However, when the power consumption of the electrical components (the amount of electrical power required for electrical components) is reduced, it is necessary to reduce the output power of the in-vehicle charger.

However, in the case of reducing the output power of the in-vehicle charger, when the output power of the in-vehicle charger is set to be equal to or lower than a minimum output power that is specified as a specification of the in-vehicle charger, the output of the in-vehicle charger is unstable, and this makes it difficult to use the in-vehicle charger. This is because, for example, in a range that is equal to or lower than the minimum output power, the phase of the leading edge of the waveform of a pulse width modulated (PWM) output current becomes unstable, so that the on-duty ratio is disturbed. Although the phase of the leading edge of the output current waveform is defined by a cross point at which a COMP signal, which corresponds to a target value of the output current, and a predetermined ramp signal cross each other, the cross point becomes inconsistent in the range equal to or lower than the minimum output power. This phenomenon occurs because the level of the COMP signal becomes low in the range equal to or lower than the minimum output power, so that a lower vertex portion of the ramp signal whose waveform has been disturbed crosses the COMP signal. When the portion of the ramp signal whose waveform has been disturbed crosses the COMP signal, the cross point is not constant with respect to the same target value (the level of the COMP signal), and as a result, the above-mentioned on-duty ratio is disturbed. Thus, in this range, it is difficult to adjust the output.

Accordingly, in order to prevent the high-voltage battery from being overcharged by reducing the output of the in-vehicle charger to the specified minimum output power or lower, it is necessary to provide an additional circuit. However, in the case where such an additional circuit is provided, there is a problem in that the number of components increases, so that the manufacturing costs of a product increases.

### SUMMARY

The present application describes a vehicle capable of preventing a battery from being overcharged without providing an additional circuit in an in-vehicle charger for reducing output power.

(1) A vehicle (e.g., a vehicle V, which will be described later) according to one aspect of the present disclosure includes a battery (e.g., a high-voltage battery 2, which will be described later) and electrical components (e.g., a battery heating unit 24, a DC-DC converter 4, and so forth, which will be described later), the battery and the electrical components being capable of being supplied with electrical power by an external power supply unit (e.g., an external power supply 80, which will be described later), state-of-charge acquiring units (e.g., a battery ECU (Electronic Control Unit) 62, a voltage sensor 25, a current sensor 26, and a temperature sensor 27, which will be described later) that acquire a value of a charging-rate parameter (e.g., the SOC or output voltage of the high-voltage battery 2, which will be described later) that is correlated with the charging rate of the battery, supplied-current-amount acquiring units (e.g., a charging ECU 61, a current sensor 41, a battery ECU 62, and a current sensor 26, which will be described later) that acquire an amount of the current supplied to the electrical components, and a control unit (e.g., a charging ECU 61, which will be described later) that controls an in-vehicle charger (e.g., an in-vehicle charger 54, which will be described later) such that, when the value of the charging-rate parameter is equal to or greater than a predetermined value (e.g., an output voltage Vh is equal to or higher than a voltage threshold Vt_th), and the supplied current amount acquired by the supplied-current-amount acquiring units is equal to or less than a predetermined amount (e.g., a supplied current amount Ia is equal to or less than a threshold Ith), charging of the battery performed by the power supply unit is stopped and that electrical power is supplied to the electrical components from the battery.

(2) In this case, it is preferable that the electrical components include a heating device for the battery (e.g., a battery heating unit 24, which will be described later).

(3) In this case, it is preferable that the control unit perform control such that the charging performed by the power supply unit is resumed when the value of the charging-rate parameter is equal to or less than a predetermined threshold.

(4) In this case, it is preferable that the control unit perform control such that the charging performed by the power supply unit is resumed when a certain period of time has elapsed since the battery has started to supply electrical power to the electrical components.

(1) In the vehicle according to one aspect of the present disclosure, when the state of charge of the battery becomes close to a fully-charged state, charging of the battery performed by the external power supply unit is stopped, and the battery supplies electrical power for operating the electrical components of the vehicle. Thus, the battery may be prevented from being overcharged by the external power supply unit without providing an additional circuit in the in-vehicle charger. In other words, when the value of the charging-rate parameter acquired by the state-of-charge acquiring unit is equal to or greater than a predetermined value, and the state of charge of the battery becomes close to the fully-charged state, if the amount of the current supplied to the electrical components acquired by the supplied-current-amount acquiring unit is equal to or less than a predetermined amount, surplus electrical power that relates to charging of the battery cannot be consumed by the electrical components, and thus, the control unit performs control such that the charging of the battery performed by the external power supply unit is stopped. Concurrently with this control, the control unit performs control such that electrical power is supplied to the electrical components from the battery. As a result, the battery may be prevented from being overcharged by the external power supply unit. In addition, as a result of causing the battery to supply electrical power to the electrical components, the state of charge of the battery may be lowered, and the charging of the battery performed by the external power supply unit may be resumed.

(2) In the vehicle according to another aspect of the present disclosure, since the electrical components include the heating device for the battery, when the temperature of the battery is low, and the battery needs to be heated even though the battery is fully charged, heating of the battery may be continued while avoiding overcharging of the battery. In addition, the heating device may be also used as a load for consuming surplus electrical power when charging of the battery is performed by the external power supply unit and as a load for lowering the state of charge of the battery.

(3) In the vehicle according to another aspect of the present disclosure, when the value of the charging-rate parameter becomes equal to or less than a threshold by causing the battery to supply electrical power to the electrical components under control of the control unit, the charging of the battery performed by the external power supply unit is resumed. As a result, charging may be performed without waste for the next driving.

(4) In the vehicle according to another aspect of the present disclosure, when a certain period of time has elapsed since the battery has started to supply electrical power to the electrical components under control of the control unit, the charging of the battery performed by the external power supply unit is resumed. As a result, charging may be performed without waste for the next driving. In the above explanation of the exemplary embodiment, specific elements with their reference numerals are indicated by using brackets. These specific elements are presented as mere examples in order to facilitate understanding, and thus, should not be interpreted as any limitation to the accompanying claims.

### BRIEF DESCRIPTION OF THE DRAWINGS

The advantages of the disclosure will become apparent in the following description taken in conjunction with the following drawings.

FIG. 1 is a diagram illustrating a vehicle according to an embodiment of the present disclosure.

FIG. 2 is a timing chart illustrating an operation of the vehicle illustrated in FIG. 1.

FIG. 3 is a flowchart illustrating an exemplary flow of a process performed by a control unit that is included in the vehicle illustrated in FIG. 1.

FIG. 4 is a flowchart illustrating another exemplary flow of a process performed by a control unit that is included in the vehicle illustrated in FIG. 1.

### DETAILED DESCRIPTION

An embodiment of the present disclosure will be described later with reference to the drawings.

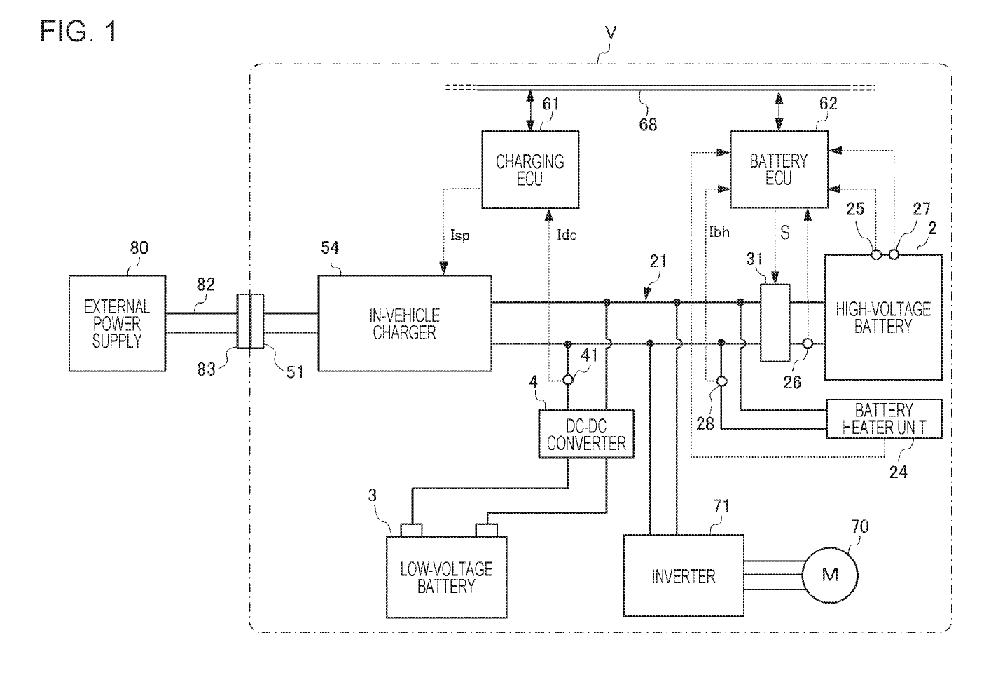

FIG. 1 is a diagram illustrating a vehicle according to the embodiment of the present disclosure.

A vehicle V has an inlet 51 through which the vehicle V receives electrical power from the outside. An external power supply 80 may feed electrical power to the vehicle V when a connector 83 disposed at an end of a charging cable 82 of the external power supply 80 is connected to the inlet 51. The electrical power fed by the external power supply 80 is supplied to an in-vehicle charger 54 whose input end is connected to the inlet 51. Accordingly, the in-vehicle charger 54 feeds electrical power that is the electrical power supplied by the external power supply 80.

The vehicle V according to the present embodiment is an electric automobile and is equipped with a high-voltage battery 2 serving as a driving power supply. Electrical power for driving a driving motor 70 is supplied to the driving motor 70 by the high-voltage battery 2 via an inverter 71. The vehicle V is provided with, in addition to the high-voltage battery 2, a low-voltage battery 3 that supplies electrical power to an illumination device and other low-voltage loads. The vehicle V is further provided with various electrical components. These electrical components include a battery heating unit 24 serving as a heating device for the high-voltage battery 2, a step-down DC-DC converter 4 used for charging the low-voltage battery 3, and so forth.

The battery heating unit 24 is formed of, for example, a PTC heater that generates heat by being energized. The PTC heater is a heater that uses a PTC element as a heating element. The PTC element generates heat by being energized and has a self-temperature control function that increases the current resistance of the PTC element and lowers the temperature of heat generated by the PTC element when the temperature of the generated heat exceeds a predetermined temperature. By using the PTC element, the heating temperature is controlled to a temperature at which current and resistance are balanced with each other. Thus, when the temperature of the high-voltage battery 2, which is to be heated by the battery heating unit 24, reaches a predetermined degree, the current supplied to the battery heating unit 24 is decreased, so that the power consumption decreases. Note that the battery heating unit 24 operates under control of a battery ECU 62, which will be described later.

The high-voltage battery 2 is charged by the in-vehicle charger 54, which has received electrical power from the external power supply 80, via a charging feeder 21. A portion of the charging feeder 21 also serves as a power line that is used when the electrical power for driving the driving motor 70 is supplied to the driving motor 70 by the high-voltage battery 2 via the inverter 71. The DC-DC converter 4 and the battery heating unit 24 are electrically connected as loads to the charging feeder 21 so as to be parallel to each other.

A main contractor 31 is disposed at an intermediate portion of the charging feeder 21, which connects an output end of the in-vehicle charger 54 and the high-voltage battery 2, on the side on which an end of the charging feeder 21 that is connected to the high-voltage battery 2 is present.

The inverter 71, the DC-DC converter 4, and the battery heating unit 24 are electrically connected, as loads of the in-vehicle charger 54, to a line of the charging feeder 21 between the in-vehicle charger 54 and the main contractor 31 so as to be parallel to each other.

The in-vehicle charger 54 receives a DC-current instruction signal Isp that is an output-current adjustment command issued by a charging ECU 61 and adjusts the output current in accordance with the value of the DC-current instruction signal Isp. The in-vehicle charger 54 includes an isolated DC-DC converter. When the value of the DC-current instruction signal Isp from the charging ECU 61 is equal to a predetermined minimum value Imin, the output of the in-vehicle charger 54 is stopped, and an output current path of the in-vehicle charger 54 is brought into a state of being galvanically interrupted.

In addition, a detected-current signal (a signal representing the amount of current Idc supplied to the DC-DC converter 4) from a current sensor 41 that detects the current supplied to the DC-DC converter 4 is input to the charging ECU 61.

Opening and closing operations that are performed by the main contractor 31 are controlled in accordance with an opening/closing command signal S from the battery ECU 62.

The battery ECU 62 calculates, on the basis of a known algorithm, a charging rate that relates to the high voltage battery 2 and that is the ratio of remaining capacity of a battery to fully-charged capacity of the battery expressed in percentage (hereinafter referred to as state of charge (SOC)) by using detection signals from sensors including a voltage sensor 25 that detects the voltage of the high-voltage battery 2, a current sensor 26 that detects output current, and a temperature sensor 27 that detects temperature. In other words, the battery ECU 62 constitutes, together with the voltage sensor 25, the current sensor 26, the temperature sensor 27, and so forth, a state-of-charge acquiring unit that acquires SOC which is a parameter of the charging-rate of the high voltage battery 2. Note that the SOC is correlated with the voltage of the high-voltage battery 2. More specifically, the SOC is likely to increase as the voltage of the high-voltage battery 2 increases. Thus, instead of the SOC, the voltage may be used as the parameter of the charging-rate of the high voltage battery 2.

A detected-current signal (a signal representing the amount of current Ibh that is supplied to the battery heating unit 24) sent by a current sensor 28 that detects the current supplied to the battery heating unit 24 is input to the battery ECU 62.

The charging ECU 61 and the battery ECU 62 are connected to each other via a CAN bus 68 so as to transmit and receive information.

The vehicle V that has been described with reference to FIG. 1 may operate in a charging-and-feeding mode in which electrical power is supplied by the external power supply 80, which is an external power supply unit, and the high-voltage battery 2 is charged with the electrical power via the in-vehicle charger 54 while the electrical power is fed to the DC-DC converter 4 and the battery heating unit 24, which are electrical components.

Operation of the vehicle V according to the present embodiment in the charging-and-feeding mode will now be described.

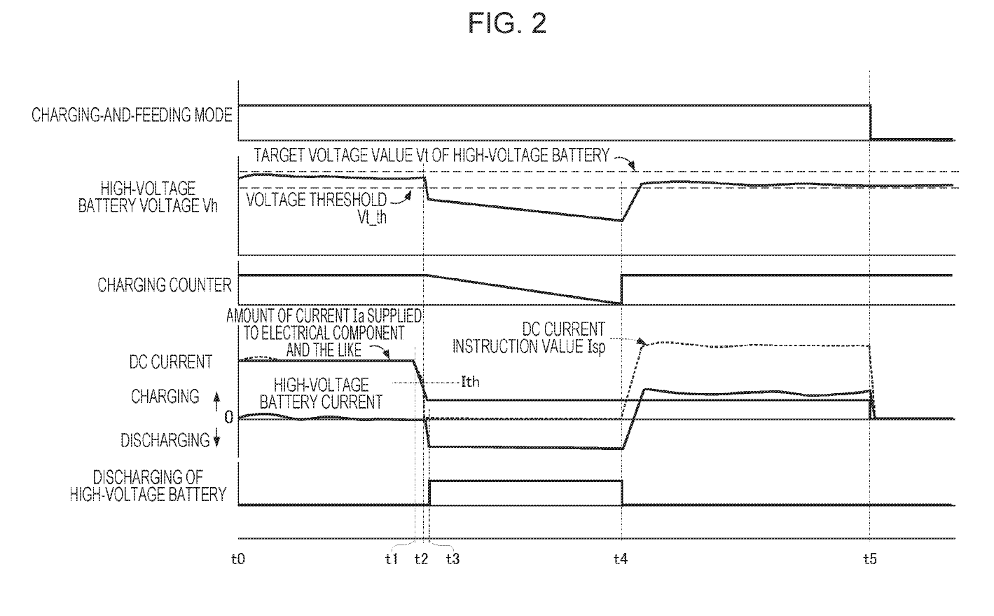

FIG. 2 is a timing chart illustrating the operation of the vehicle V in the charging-and-feeding mode. Note that an example of the operation of the vehicle V in the charging-and-feeding mode when the vehicle V is in a cryogenic environment will be described later. More specifically, an example of the operation of the vehicle V in the charging-and-feeding mode when the temperature of the high-voltage battery 2 is equal to or lower than a predetermined temperature (e.g., below freezing), and the high-voltage battery 2 needs to be heated by the battery heating unit 24 even though the high-voltage battery 2 is apparently fully charged will be described.

In the charging-and-feeding mode, the vehicle V operates under control of the charging ECU 61 that operates in cooperation with the battery ECU 62.

At observation starting time t0 in FIG. 2, the connector 83 disposed at the end of the charging cable 82 is connected to the inlet 51, and the vehicle V has started to operate in the charging-and-feeding mode in which charging of the high-voltage battery 2 and feeding of electrical power to the DC-DC converter 4 and the battery heating unit 24 are performed by using the electrical power supplied by the external power supply 80.

An output voltage Vh of the high-voltage battery 2 at time t0 is equal to or higher than a voltage threshold Vt_th that is set to be somewhat smaller than a target voltage value Vt relating to the high-voltage battery 2 in a state of being charged. The target voltage value Vt is the output voltage of the high-voltage battery 2 that corresponds to the case where the value of the SOC is a value indicating that the high-voltage battery 2 is nearly fully charged. Thus, when the output voltage Vh of the high-voltage battery 2 is equal to or higher than the voltage threshold Vt_th, the state of the high-voltage battery 2 is in a state of being nearly fully charged, and it is necessary to reduce the charging current supplied to the high-voltage battery 2 so as to prevent the high-voltage battery 2 from being overcharged.

Meanwhile, at time t0, the amount of current Ia supplied to the electrical components is at a certain level or higher. The supplied current amount Ia includes the sum of the amount of the current supplied to the DC-DC converter 4 (hereinafter suitably referred to as supplied current amount Idc) and the amount of the current supplied to the battery heating unit 24 (hereinafter suitably referred to as supplied current amount Ibh), the DC-DC converter 4 and the battery heating unit 24 being electrically connected to the feeder 21 in FIG. 1 so as to be parallel to each other, and may also include the amount of current supplied to an air conditioner and other auxiliary equipment. Here, the sum of the supplied current amount Idc and the supplied current amount Ibh is treated as the amount of the current Ia supplied to the electrical components.

As described above, the battery heating unit 24 uses the PTC element as a heating element, and when the temperature of the high-voltage battery 2, which is to be heated by the battery heating unit 24, reaches the predetermined value, the amount of the current Ibh supplied to the battery heating unit 24 is decreased, so that the power consumption decreases.

The charging ECU 61 calculates the amount of the current Ia supplied to the electrical components by adding the supplied current amount Idc and the supplied current amount Ibh together.

As illustrated in the period from time t0 to time t1, when the amount of the current Ia supplied to the electrical components is equal to or greater than a value that corresponds to the minimum output power of the in-vehicle charger 54, charging power supplied by the in-vehicle charger 54 is sufficiently consumed by the electrical components, and thus, the high-voltage battery 2 will not be overcharged.

However, when the charging current supplied to the low-voltage battery 3 is reduced, the supplied current amount Idc decreases, and when the temperature of the high-voltage battery 2 reaches near a target value, the supplied current amount Ibh decreases as described above. Consequently, in such a situation, the amount of the current Ia supplied to the electrical components decreases. In the case illustrated in FIG. 2, the supplied current amount Ia, which is indicated by a solid line, starts to decrease significantly at time t1 and becomes equal to or less than a predetermined threshold Ith at time t2.

The threshold Ith has been registered in advance as a value corresponding to the specified minimum output power of the in-vehicle charger 54 in the charging ECU 61. The amount of the current Ia supplied to the electrical components corresponds to the power consumption of the electrical components, and when the supplied current amount Ia is equal to or less than the threshold Ith, that is, the supplied current amount Ia is equal to or less than the value corresponding to the specified minimum output power of the in-vehicle charger 54, the electrical components cannot consume all the output power of the in-vehicle charger 54, and as a result, there is a possibility that a surplus amount of the electrical power supplied by the in-vehicle charger 54 will be supplied to the high-voltage battery 2, which in turn leads to overcharging of the high-voltage battery 2. Therefore, the charging ECU 61 constantly monitors the changing state of the supplied current amount Ia.

During the period from time t0 to time t1, the charging ECU 61 maintains the value of the DC-current instruction signal Isp that is supplied to the in-vehicle charger 54 at a substantially constant level equal to or greater than the predetermined minimum value Imin. On the other hand, the charging ECU 61 lowers the value of the DC-current instruction signal Isp as the supplied current amount Ia starts to decrease at time t1. The charging ECU 61 immediately sets the value of the DC-current instruction signal Isp to the predetermined minimum value Imin at time t2 at which the output voltage Vh of the high-voltage battery 2 is equal to or higher than the voltage threshold Vt_th and at which the supplied current amount Ia is equal to or less than the predetermined threshold Ith.

As described above, when the value of the DC-current instruction signal Isp from the charging ECU 61 is set to the minimum value Imin, the output of the in-vehicle charger 54 is stopped, and the output current path of the in-vehicle charger 54 is brought into a state of being galvanically interrupted.

The charging ECU 61 stops and interrupts the in-vehicle charger 54 at time t2 and, on the other hand, maintains a closed state of the main contractor 31 that has been closed at observation starting time to.

Thus, at time t2, the in-vehicle charger 54 stops to charge the high-voltage battery 2, and the high-voltage battery 2 starts to feed electrical power to the DC-DC converter 4 and the battery heating unit 24. In other words, at time t2, the high-voltage battery 2 transitions from a state of being charged to a state of discharging.

In response to the high-voltage battery 2 making a transition to the discharging state as described above, the output voltage Vh starts to decrease.

Meanwhile, a charging counter that is set to perform a time-delay operation in the charging ECU 61 at time t2 starts down counting. The time-delay operation of the charging counter is a timekeeping operation for measuring the period of time from when the high-voltage battery 2 that is in the state of being nearly fully charged starts to discharge electrical power until it is assumed that the SOC or the voltage of the high-voltage battery 2 has reached a value at which there will be no problem even if the high-voltage battery 2 receives the charging power.

At time t4 at which the down counting performed by the charging counter has advanced, and the count value reaches zero, the SOC or the voltage of the high-voltage battery 2 reaches the value at which there will be no problem even if the high-voltage battery 2 receives the charging power.

At time t4, the in-vehicle charger 54 resumes the charging operation by causing the current to flow through the output current path thereof, which had been galvanically interrupted as a result of the value of the DC-current instruction signal Isp being set to the minimum value Imin, and returns to the state of charging the high-voltage battery 2.

After at time t4, the charging ECU 61 supplies the DC-current instruction signal Isp having a value above the amount of the current Ia supplied to the electrical components to the in-vehicle charger 54 until time t5 in such a manner that the high-voltage battery 2 is charged with the output of the in-vehicle charger 54 while the output of the in-vehicle charger 54 covers the amount of the current Ia supplied to the electrical components.

At a predetermined time t5, which is after time t4, the charging ECU 61 lowers the value of the DC-current instruction signal Isp, which has been supplied to the in-vehicle charger 54, to the minimum value Imin in such a manner as to terminate the operation of the in-vehicle charger 54 and ends the operation in the charging-and-feeding mode.

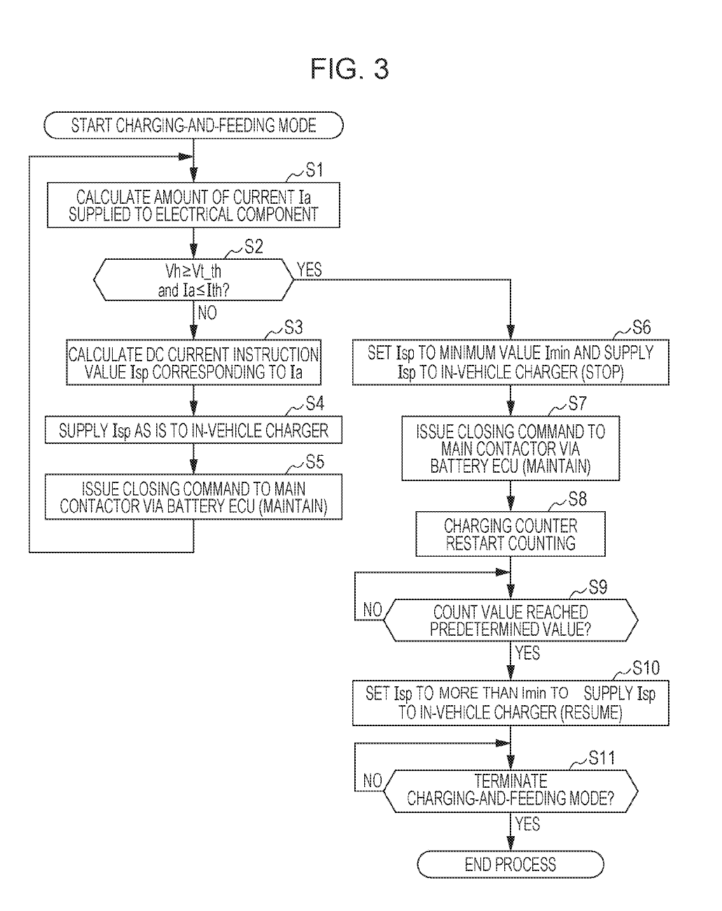

FIG. 3 is a flowchart illustrating an exemplary flow of a process performed by a control unit that is included in the vehicle illustrated in FIG. 1.

The flowchart in FIG. 3 illustrates an exemplary flow of a process performed by the charging ECU 61 of the vehicle V in the charging-and-feeding mode. The charging ECU 61 determines whether the output voltage Vh of the high-voltage battery 2 that is acquired through the battery ECU 62 is equal to or higher than the above-mentioned voltage threshold Vt_th. When it is determined that the output voltage Vh is equal to or lower than the voltage threshold Vt_th, the in-vehicle charger 54 is caused to concurrently perform charging of the high-voltage battery 2 and feeding of electrical power to the electrical components including the DC-DC converter 4 and the battery heating unit 24, and when it is determined that the output voltage Vh is equal to or higher than the voltage threshold Vt_th, the in-vehicle charger 54 is caused to only perform feeding of electrical power to the electrical components.

In step S1, the charging ECU 61 calculates the amount of the current Ia supplied to the electrical components. This calculation is performed by adding the amount of the current Idc supplied to the DC-DC converter 4 detected by the current sensor 41 and the amount of the current Ibh supplied to the battery heating unit 24, which is a value that is detected by the current sensor 28 and that is acquired by being transferred from the battery ECU 62, together. After the charging ECU 61 has performed the processing in step S1, the process continues to step S2.

In step S2, the charging ECU 61 determines whether the output voltage Vh of the high-voltage battery 2 is equal to or higher than the above-mentioned voltage threshold Vt_th and whether the supplied current amount Ia calculated in step S1 is equal to or less than the above-mentioned threshold Ith. In the case where the determination result in step S2 is NO, that is, in the case where the output voltage Vh is equal to or lower than the above-mentioned voltage threshold Vt_th or in the case where the supplied current amount Ia is equal to or greater than the threshold Ith, the process performed by the charging ECU 61 continues to step S3.

In step S3, the charging ECU 61 calculates the value of the DC-current instruction signal Isp that corresponds to the amount of the current Ia supplied to the electrical components. Specifically, the charging ECU 61 calculates the value of the DC-current instruction signal Isp by taking into consideration the value of the supplied current amount Ia and the SOC of the high-voltage battery 2 acquired from the battery ECU 62. As described above, the DC-current instruction signal Isp is an output-current adjustment command that is issued by the charging ECU 61 to the in-vehicle charger 54. The in-vehicle charger 54 receives the DC-current instruction signal Isp from the charging ECU 61 and adjusts the output current in accordance with the value of the DC-current instruction signal Isp. After the charging ECU 61 has performed the processing in step S3, the process continues to step S4.

In step S4, the charging ECU 61 supplies, as an output-current adjustment command, the DC-current instruction signal Isp, which has been calculated in step S3, as is to the in-vehicle charger 54, and the process continues to step S5.

In step S5, the charging ECU 61 supplies the opening/closing command signal S to the main contractor 31 via the CAN bus 68 and the battery ECU 62. Alternatively, the charging ECU 61 maintains supply of the opening/closing command signal S and causes the main contractor 31 to be closed. Alternatively, the charging ECU 61 maintains the closed state of the main contractor 31.

In step S5, the output current that is output by the in-vehicle charger 54 in accordance with the value of the DC-current instruction signal Isp, which has been supplied to the in-vehicle charger 54 by the charging ECU 61, is supplied to the high-voltage battery 2 via the main contractor 31, which has been closed, such that the high-voltage battery 2 is charged. After the charging ECU 61 has performed the processing in step S5, the process returns to step S1.

In the case where the determination result in step S2 is YES, that is, in the case where the output voltage Vh is equal to or higher than the voltage threshold Vt_th and where the supplied current amount Ia is equal to or less than the above-mentioned threshold Ith, the process performed by the charging ECU 61 continues to step S6. In a state where the supplied current amount Ia is equal to or less than the above-mentioned threshold Ith, the electrical components cannot consume all the output power of the in-vehicle charger 54, and as a result, there is a possibility that a surplus amount of the electrical power will be supplied by the in-vehicle charger 54 to the high-voltage battery 2, which in turn leads to overcharging of the high-voltage battery 2.

In step S6, the charging ECU 61 immediately sets the value of the DC-current instruction signal Isp, which is supplied to the in-vehicle charger 54, to the predetermined minimum value Imin. This stops the output of the in-vehicle charger 54, and the output current path of the in-vehicle charger 54 is brought into a state of being galvanically interrupted. As a result of the output of the in-vehicle charger 54 being stopped and the output current path of the in-vehicle charger 54 being brought into the state of being galvanically interrupted, charging of the high-voltage battery 2 that has been performed by the in-vehicle charger 54 is stopped. After the charging ECU 61 has performed the processing in step S6, the process continues to step S7.

In step S7, the charging ECU 61 maintains the closed state of the main contractor 31, which has been maintained during the processing in step S6.

As a result of the charging ECU 61 performing the processing in step S7, the output of the high-voltage battery 2 is supplied to the DC-DC converter 4 and the battery heating unit 24 via the main contractor 31, which has been closed. In other words, the high-voltage battery 2 transitions from the state of being charged to the state of discharging.

The processing in step S6 and the processing in step S7 are performed at time t2 in the timing chart illustrated in FIG. 2. After the charging ECU 61 has performed the processing in step S7, the process continues to step S8.

In step S8, the charging ECU 61 causes the charging counter, which is set to perform a time-delay operation, to start down counting from a predetermined value. As described above, the time-delay operation of the charging counter is a timekeeping operation for measuring the period of time from when the high-voltage battery 2 that is in the state of being nearly fully charged starts to discharge electrical power until it is assumed that the SOC or the voltage of the high-voltage battery 2 has reached a value at which there will be no problem even if the high-voltage battery 2 receives the charging power. After the charging ECU 61 has performed the processing in step S8, the process continues to step S9.

In step S9, the charging ECU 61 determines whether the down counting performed by the charging counter has advanced, and the count value has reached a predetermined value, which is zero. When the charging ECU 61 determines that the count value counted by the above-mentioned charging counter has reached zero, the process continues to step S10.

The charging ECU 61 causes the above-mentioned charging counter to continue the down counting unless the count value counted by the charging counter reaches zero. The period when the charging counter is continuing the down counting corresponds the period from time t2 to time t4 in the timing chart illustrated in FIG. 2. As described above, the high-voltage battery 2 is in the discharging state during the period when the charging counter is continuing the down counting, and the output voltage Vh, which is correlated with the SOC, starts to decrease.

In step S10, the charging ECU 61 gradually increases the value of the DC-current instruction signal Isp from the minimum value Imin, which corresponds to the state of being stopped charging, to a substantially constant level slightly higher than the level immediately before the in-vehicle charger 54 is caused to stop charging in step S6. Thus, the in-vehicle charger 54 resumes the charging operation and returns to the state of concurrently performing charging of the high-voltage battery 2 and feeding of electrical power to the electrical components. After the charging ECU 61 has performed the processing in step S10, the process continues to step S11.

In step S11, the charging ECU 61 determines whether the charging-and-feeding mode is to be terminated. The charging-and-feeding mode is to be terminated when the output voltage Vh of the high-voltage battery 2 acquired through the battery ECU 62 is equal to or higher than the above-mentioned voltage threshold Vt_th, and the temperature of the high-voltage battery 2 is equal to or higher than a threshold that relates to temperature characteristics, so that the power consumption of the battery heating unit 24 is zero.

When it is determined that the charging-and-feeding mode is to be terminated, the charging ECU 61 terminates the charging-and-feeding mode. The charging ECU 61 repeats the determination in step S11 unless it is determined that the charging-and-feeding mode is to be terminated. During the period when the charging ECU 61 is repeating the determination, charging is maintained.

As described above, according to the embodiment of the present disclosure, in order to avoid overcharging caused by a surplus amount of electrical power that is not consumed by the electrical components even if the output of the in-vehicle charger 54 is reduced to the minimum output power, the high-voltage battery 2 transitions from the state of being charged to the state of discharging and then returns to the state of being charged. In the present embodiment, which has been described with reference to the flowchart illustrated in FIG. 3, when the high-voltage battery 2 returns to the state of being charged after making a transition to the discharging state, it is assumed, by the amount of time elapsed since the transition of the high-voltage battery 2 to the discharging state, that the high-voltage battery 2 is in a state in which there will be no problem even if charging of the high-voltage battery 2 is resumed.

However, the present disclosure is not limited to the above-described embodiment. That is to say, in the flowchart illustrated in FIG. 3, although the timing at which the high-voltage battery 2 returns to the state of being charged after making a transition to the discharging state is managed on the basis of the amount of time elapsed since the transition of the high-voltage battery 2 to the discharging state (see step S8 and step S9 in FIG. 3), the timing at which the high-voltage battery 2 returns to the state of being charged may be managed on the basis of the SOC of the high-voltage battery 2. Another aspect in which the timing at which the high-voltage battery 2 returns to the state of being charged is managed on the basis of the SOC of the high-voltage battery 2 will now be described with reference to another flowchart.

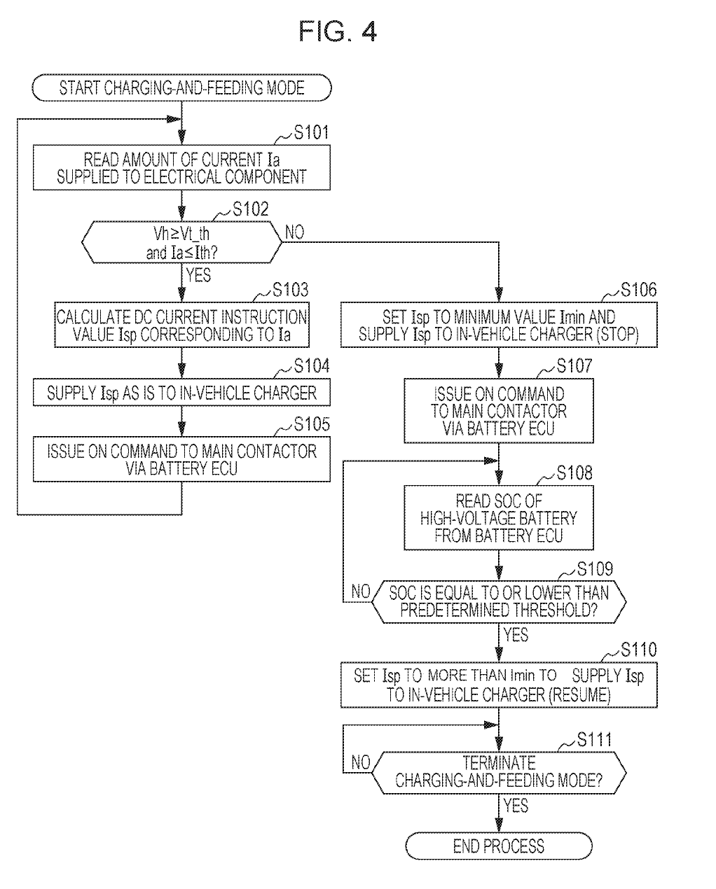

FIG. 4 is a flowchart illustrating another exemplary flow of a process performed by the control unit that is included in the vehicle illustrated in FIG. 1.

The flowchart in FIG. 4 also illustrates an exemplary flow of a process performed by the charging ECU 61 of the vehicle V in the charging-and-feeding mode.

The flowchart illustrated in FIG. 4 has steps S101 to S111, and steps S101 to S107 correspond to steps S1 to S7 in the flowchart illustrated in FIG. 3.

In addition, steps S110 and S111 in the flowchart illustrated in FIG. 4 correspond to steps S10 and S11 in the flowchart illustrated in FIG. 3.

Accordingly, the steps in the flowchart illustrated in FIG. 4 that are common to the above-described flowchart illustrated in FIG. 3 rely on the descriptions of the steps in the flowchart illustrated in FIG. 3.

In the case illustrated in FIG. 4, in step S106 that corresponds to step S6 in FIG. 3, the charging ECU 61 immediately sets the DC-current instruction signal Isp, which is an output-current adjustment command issued to the in-vehicle charger 54, to the predetermined minimum value Imin and stops the operation of the in-vehicle charger 54. In step S107 that corresponds to step S7 in FIG. 3, the charging ECU 61 maintains the closed state of the main contractor 31 and causes the high-voltage battery 2 to discharge electrical power to the loads, which are the electrical components, and the process continues to step S108.

In step S108, the charging ECU 61 reads the SOC of the high-voltage battery 2 from the battery ECU 62 via the CAN bus 68, and the process continues to step S109.

In step S109, the charging ECU 61 determines whether the value of the SOC, which has been read by the charging ECU 61 in step S108, is equal to or less than a predetermined threshold. The predetermined threshold relating to the SOC is a value at which the SOC is lower than that in a state where the high-voltage battery 2 is fully charged and at which the high-voltage battery 2 is not likely to be overcharged even if charging of the high-voltage battery 2 is resumed.

When the charging ECU 61 determines that the value of the SOC, which has been read by the charging ECU 61 in step S108, is equal to or less than the predetermined threshold, the process continues to step S110, and when the charging ECU 61 determines that the value of the SOC is greater than the predetermined threshold, the charging ECU 61 continues step S109. The processing in step S110 is the same as that in step S10, which has been described with reference to FIG. 3.

Although the embodiment of the present disclosure has been described with reference to the drawings, the present disclosure is not limited to the above-described aspects. Various modifications and changes may be made within the scope of the present disclosure. For example, the embodiment has been described above focusing on, as representative examples of electrical components, the battery heating unit 24 serving as a heating device for the high-voltage battery 2 and the step-down DC-DC converter 4 used for charging the low-voltage battery 3. The amount of the current Ia supplied to the battery heating unit 24 and the DC-DC converter 4 is acquired by the charging ECU 61, and when the acquired amount is equal to or less than a predetermined amount, the state of the high-voltage battery 2 is switched from a state of being charged to a state of discharging electrical power to the electrical components. However, the electrical components are not limited to the battery heating unit 24 and the DC-DC converter 4 and may include an air conditioner, a cooling device, an illumination device, and so forth. In this case, when the electrical components consume a surplus amount of the electrical power that is supplied by the in-vehicle charger 54 and that is not used for charging the high-voltage battery 2, the probability of the high-voltage battery 2 being overcharged may be effectively reduced by bringing the air conditioner, the illumination device, and so forth into an energized state. In addition, by increasing the power consumption when the high-voltage battery 2 discharges electrical power, the high-voltage battery 2 may be promptly brought into a rechargeable state.

In the above-described embodiment, although feeding of electrical power to the battery heating unit 24 is performed by the high-voltage battery 2, the DC-DC converter 4 may feed electrical power to the battery heating unit 24.

In addition, in the above-described embodiment, a value that is calculated as the amount of required electrical power to be supplied to the loads may be used as the amount of the current Ia supplied to the battery heating unit 24 and the DC-DC converter 4 regardless of an actually measured value. Although a specific form of embodiment has been described above and illustrated in the accompanying drawings in order to be more clearly understood, the above description is made by way of example and not as limiting the scope of the invention defined by the accompanying claims. The scope of the invention is to be determined by the accompanying claims. Various modifications apparent to one of ordinary skill in the art could be made without departing from the scope of the invention. The accompanying claims cover such modifications.

What is claimed is:

1. A vehicle comprising:
a battery and an electrical component that are supplied with electrical power by an external power supply unit;
a state-of-charge acquiring unit that acquires a value of a charging-rate parameter that is correlated with a charging rate of the battery;
a supplied-current-amount acquiring unit that acquires an amount of current supplied to the electrical component;
an in-vehicle charger configured to receive the electrical power from the external power supply unit and supply the electrical power to the battery; and
a control unit that controls the in-vehicle charger such that, when the value of the charging-rate parameter is equal to or greater than a predetermined value, and the amount of supplied current acquired by the supplied-current-amount acquiring unit is equal to or lower than a predetermined amount, supplying of the electrical power from the power supply unit to the battery to charge the battery is stopped and the electrical power is supplied to the electrical component from the battery.

2. The vehicle according to claim 1,
wherein the electrical component includes a heating device for the battery.

3. The vehicle according to claim 1,
wherein the control unit performs control such that the charging performed by the power supply unit is resumed when the value of the charging-rate parameter is equal to or less than a predetermined threshold.

4. The vehicle according to claim 1,
wherein the control unit performs control such that supplying of the electrical power from the power supply unit to the battery to charge the battery is resumed when a certain period of time has elapsed since the battery has started to supply the electrical power to the electrical component.

5. The vehicle according to claim 1,
wherein the predetermined amount is a specified minimum output power of the in-vehicle charger.

6. The vehicle according to claim 5,
wherein the specified minimum output power of the in-vehicle charger is an output power at which or at lower than which an output of the in-vehicle charger becomes unstable.

7. The vehicle according to claim 1,
wherein the value of the charging-rate parameter is a state-of-charge (SOC) of the battery.

8. The vehicle according to claim 1,
wherein the value of the charging-rate parameter is a voltage of the battery.

9. The vehicle according to claim 1,
wherein the control unit performs control such that the charging performed by the power supply unit is resumed when the amount of supplied current acquired by the supplied-current-amount acquiring unit becomes greater than the predetermined amount.

10. A battery charging method for a vehicle equipped with a battery and an electrical component that are supplied with electrical power by an external power supply unit, the method comprising steps of:
acquiring, by using a computer, a value of a charging-rate parameter that is correlated with a charging rate of the battery;
acquiring, by using a computer, an amount of current supplied to the electrical component; and
controlling, by using a computer, an in-vehicle charger such that, when the value of the charging-rate parameter is equal to or greater than a predetermined value, and the amount of supplied current is equal to or lower than a predetermined amount, supplying of the electrical power from the power supply unit to the battery to charge the battery is stopped and the electrical power is supplied to the electrical component from the battery.
